(19) United States
(12) Patent Application Publication
(10) Pub. No.: US 2013/0291338 A1
(43) Pub. Date: Nov. 7, 2013

(54) ROLL UP DOOR HANDLE LATCH AND BRACKET

(71) Applicants: Charles Ryan Malott, Valparaiso, IN (US); Carrie J. Ackenhusen, Valparaiso, IN (US); James D. O'Rourke, Pewaukee, WI (US); Luc P. Piessens, Brookfield, WI (US)

(72) Inventors: Charles Ryan Malott, Valparaiso, IN (US); Carrie J. Ackenhusen, Valparaiso, IN (US); James D. O'Rourke, Pewaukee, WI (US); Luc P. Piessens, Brookfield, WI (US)

(21) Appl. No.: 13/710,038

(22) Filed: Dec. 10, 2012

Related U.S. Application Data
(60) Provisional application No. 61/569,015, filed on Dec. 9, 2011.
(60) Provisional application No. 61/569,036, filed on Dec. 9, 2011.

(51) Int. Cl. E05C 19/00

(52) U.S. Cl. CPC E05C 19/00
USPC 16/412

(57) ABSTRACT

A latch spring mechanism for a roll up door utilizes the inherent spring properties of a material to replicate the opening, closing, and tensioning that exists in mechanical spring latches. The latch may be manufactured as a simplified single component rather than a complicated multiple piece assembly.

### CROSS-REFERENCE TO RELATED APPLICATION

This application is based on and claims priority to U.S. Provisional Patent Application Nos. 61/569,015 and 61/569,036 filed on Dec. 9, 2011, which are incorporated herein by reference in its entirety for all purposes.

### FIELD OF THE INVENTION

The present invention relates to roll up doors, or tambour doors. More particularly, the present invention relates to tensioned roll up doors which utilize a latching mechanism for retention of the door in a closed position.

### BACKGROUND

Roll up doors of this type are often found on utility type and fire rescue vehicles. These types of doors may also be found on machinery, kiosks, or as building room separators. Doors of this type often utilize a bar type handle for the manual opening and closing operation of the door. These doors also typically have a spring loaded roller to provide lifting assistance for the person operating the door. It is therefore desirable to have a latching system to retain the door in a closed position to prevent unintended axial movement of the door and accidental opening of the compartment being protected by the door.

The standard latching system used in this field is through the use of retention blocks mounted on the sides of the roll up door frame. These blocks restrain the operating handle from moving axially unless the handle is manually pivoted away from the blocks. Similarly, the handle must pivot away from the blocks in the closing operation to allow for restrained locating of the handle in the closed position. Due to the pivoting nature of the handle and the retention requirement of the handle at a closed door position, in relation to the retention blocks, the handle requires its own tensioning system. The current practice of tensioning the bar type door handle is through the use of a multi-piece spring latch in which one part of the latch is mounted to the roll up door itself and the other part of the latch is mounted to, or captures, the handle. The two parts of the latch utilize a single pivot and a mechanical spring which forces the latch, and therefore the handle, to a restrained position in its closed state but allows for the handle to be forcefully moved away from this restrained, closed position as well. This spring latch allows for the retention block to force the handle away from the closed position when the door moves past the retention block upon closing and then draws the handle to a restrained position on the opposite side of the retention block. In order for the door to open, the spring latch must be forcefully pivoted to an open position to allow the handle to be moved to a position away from the retention block where it can be moved axially past the retention block.

The problem associated with existing latches that are used on roll up doors is that it they are manufactured from multiple components and are expensive due to the assembly required. They are also manufactured from multiple materials which require one to ensure material compatibility in its function and in its environment. Additionally, there is a pivot point which can cause wear problems that, in turn, may lead to operational problem as the latch is forcefully moved to an open position. An additional problem with existing latch systems is that the force required to open the latch is significant. Because the spring latch is a singularly mounted component, the force applied to the door is very high at the mounting point of the latch. Due to the high stress applied by the spring latch at the attachment point, a very structurally sound base is required on the door for attachment of the latch. It is typical in roll up doors to have this structurally sound base covering the entire width of the door. It is expensive to accommodate the localized stress applied by the spring latch by assembling a very large structural panel into the roll up door.

As such, there is a need for a simplified latching mechanism which does not rely on a multi-component, pivoting, assembly but is capable of providing the same mechanical latching functionality as existing roll up door handle latches. There is also a need for a mounting bracket that can be smaller in size and more cost effective but also capable of distributing the loading stresses applied by the latch to a large area, but without incorporating an entire structural panel.

### SUMMARY

The present invention relates to a latch mechanism for use with a door including a base removably attached to a door, a protrusion integrally formed and extending from the base. The protrusion including a support portion, a flexible spring arm portion, a door handle receiving opening, and a limiter catch. The flexible spring arm portion having a generally arcuate shape that progressively increases the force needed to extend the spring as it pivots away from the base. The latch mechanism also includes a limiter protrusion integrally formed and extending from the base that engages the limiter catch when the latch mechanism is actuated to prevent the flexible spring portion from extending beyond the elastic deformation limit of the flexible spring arm.

In alternative embodiments of the invention, a latch as described herein may be provided with a conventional mounting and mounted on a door, a latch as described herein may be provided with a latch bracket as described herein and mounted on a door, or a conventional latch may be provided with a latch bracket as described herein and mounted on a door. Additional variations and embodiments are also possible without departing from the invention.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a roll up door latch in accordance with the invention.

FIG. 2 is a detail view of the roll up door latch of FIG. 1 taken generally along the line 2-2 and shown mounted to a door and with a handle disposed therein.

FIG. 3 is a perspective view of the roll up door latch of FIG. 1 shown without the handle disposed therein and not mounted to the door.

FIG. 3A is a perspective view of an alternative embodiment of a roll up door latch in accordance with the invention.

FIG. 4 is an exploded perspective partial view of the roll up door latch of FIG. 1.

FIG. 5 is a side view of the roll up door latch of FIG. 1 with the door shown in cross-section taken generally along with line 5-5 in FIG. 1 and the handle positioned under the retention block.

FIG. 6 is another side view of the roll up door latch of FIG. 5 with the spring portion in its extended position and the handle unlatched from the retention block.

FIG. 7 is another side view of the roll up door latch of FIG. 5 showing the latch in a disengaged position.

FIG. 8 is a perspective view of one alternative embodiment of a roll up door latch in accordance with the invention.

FIG. 9 is another perspective view of the roll top door latch of FIG. 8 showing the latch in an extended position.

FIG. 10 is another perspective view of the roll up door latch of FIG. 8.

FIG. 11 is another perspective view of the roll up door latch of FIG. 8 showing the latch in an extended position.

FIG. 12 is a perspective view of another alternative embodiment of a roll up latch in accordance with the invention.

FIG. 13 is another perspective view of the roll up latch of FIG. 12 showing the latch in an extended position.

FIG. 14 is a perspective view of one embodiment of a roll up latch in accordance with the invention.

FIG. 15 is a perspective view of the base of the roll up latch of FIG. 14.

FIG. 16 is a perspective view of a latch portion of the roll up latch of FIG. 14.

### DETAILED DESCRIPTION

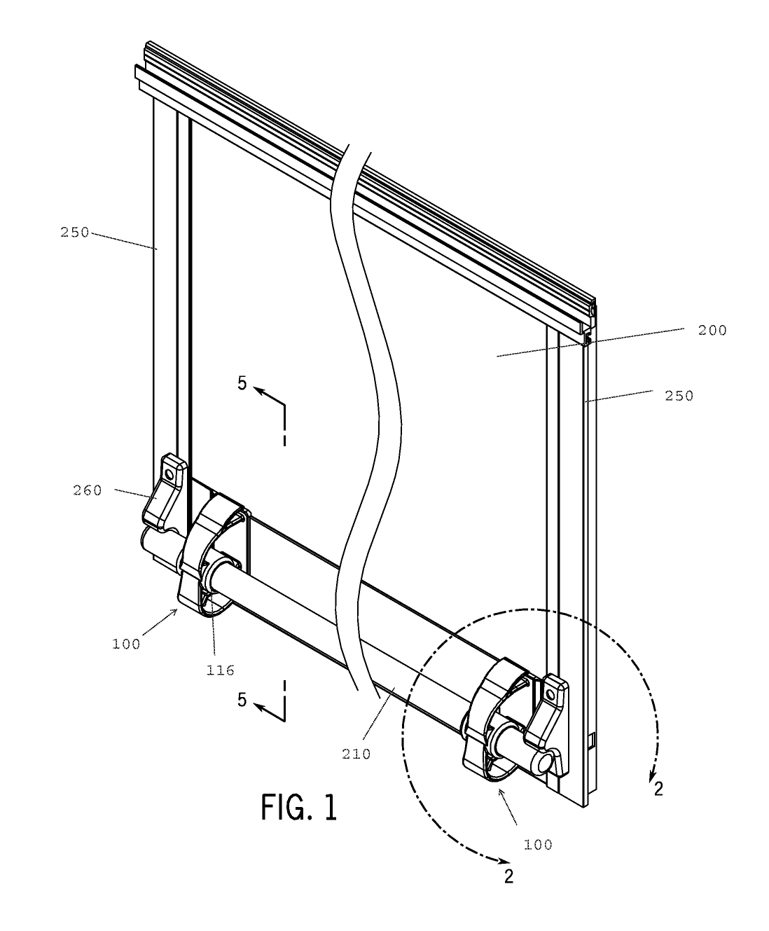

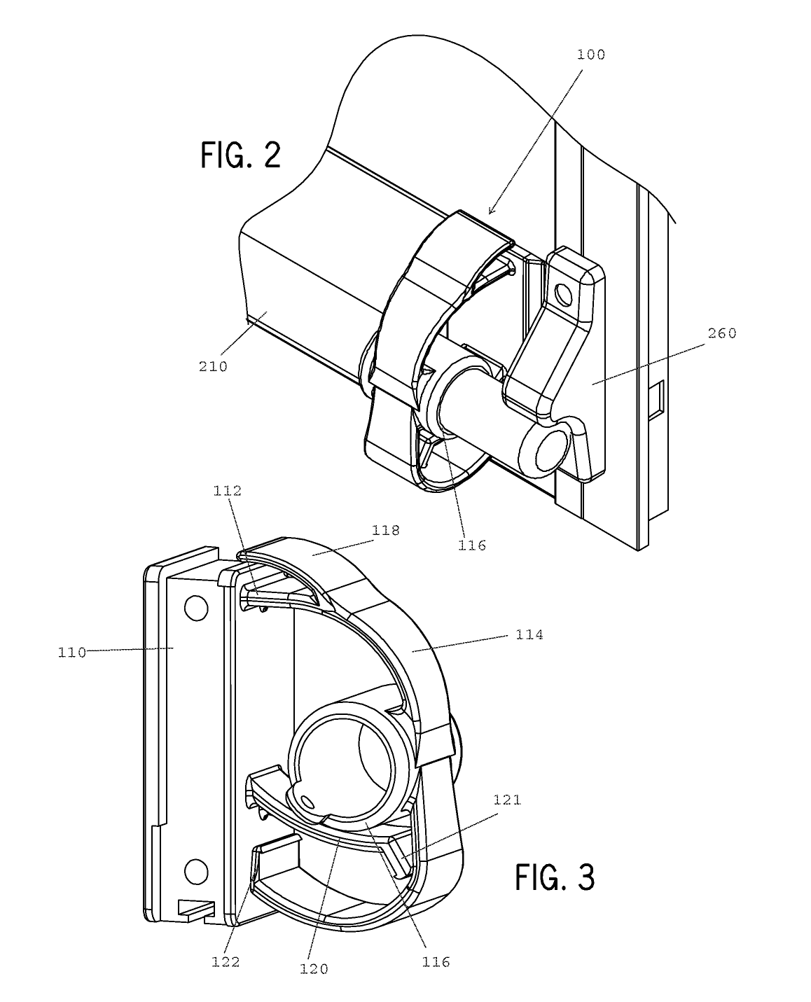

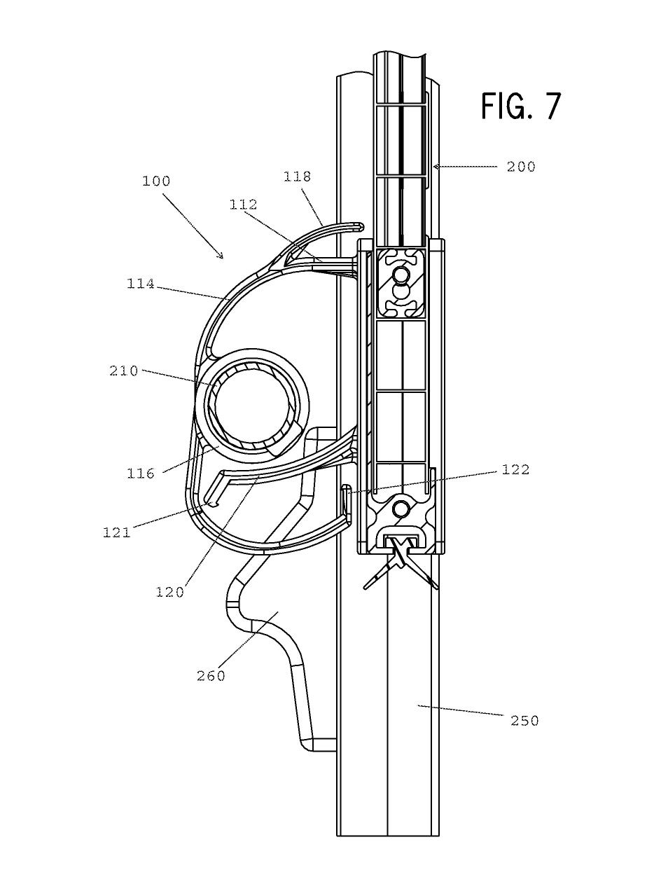

Turning now to FIGS. 1-7, one embodiment of a roll up door handle latch 100 in accordance with the invention is shown. As shown in FIG. 1, two roll up door handle latches 100 are attached to the bottom of a roll up door 200. A bar type door handle 210 passes through door handle mounts 116 in the roll up door handle latch 100. The bar type door handle 210 is removably attached to the door handle mounts 116. Of course, the bar type door handle 210 could be attached to the door handle mounts 116 by any other means without departing from the invention. The roll up door 200 is captured in a roll up door frame 250. On each side of the roll up door frame 250 are retention blocks 260. The retention blocks 260 retain the door handle 210, preventing the roll up door 200 from opening inadvertently. The roll up door handle latch 100 and door handle 210 must exert enough force on the retention blocks 260 to prevent the roll up door 200 from inadvertently opening when a utility vehicle is in motion, even over rough terrain.

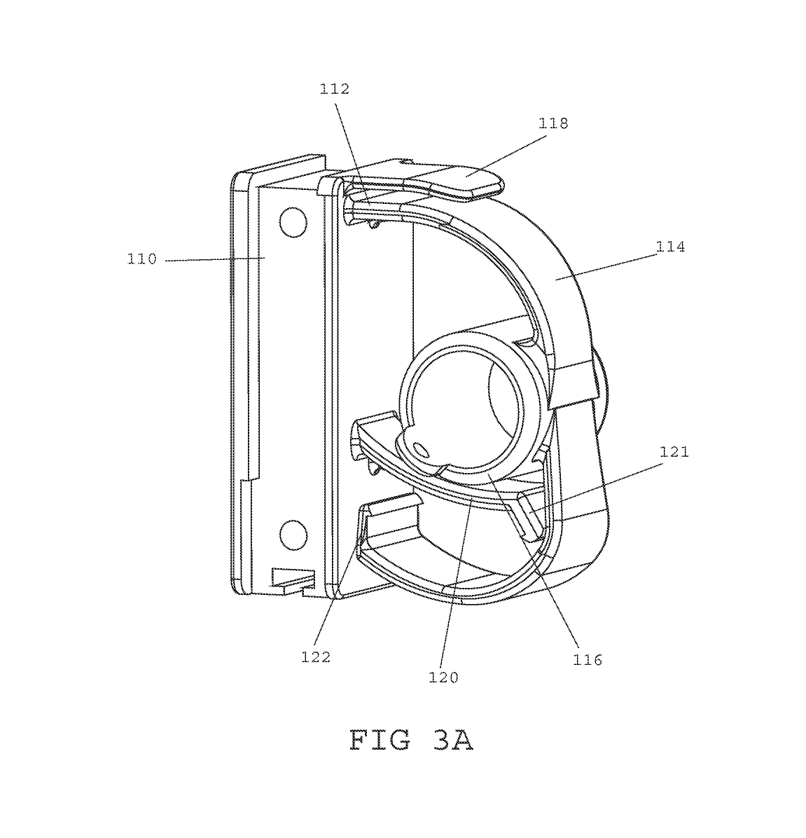

Turning now to FIG. 3, the roll up door handle latch 100 is shown. The roll up door handle latch 100 is a component of a material and geometric shape that is able to locate the handle in a fixed position relative to the retention blocks on a roll up door while allowing enough flexibility to allow the handle to be forcibly moved away from the retention blocks to permit operation of the door. The roll up door handle latch 100 includes a base 110, a top support 112, spring portion 114, a handle mount 116, a guard 118, a limiter 120, and a limiter catch 122.

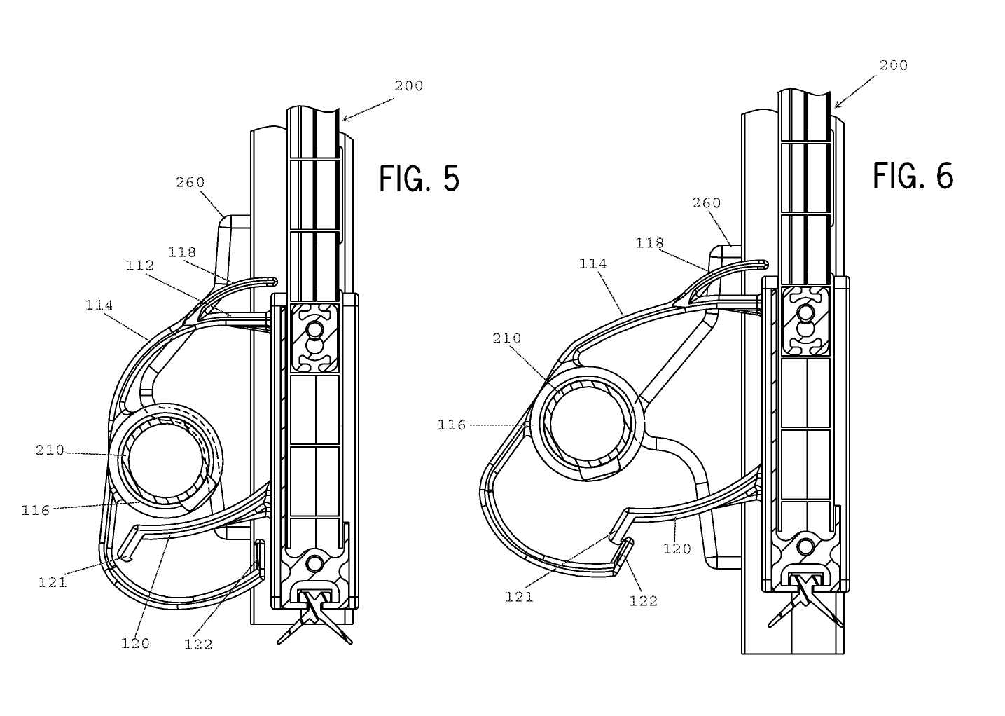

As shown in FIGS. 5-7, the spring portion 114 utilizes the inherent spring properties of a material to replicate the opening, closing, and tensioning that exists with the current multi-component mechanical spring latch. In the embodiment shown, the roll up door handle latch 100 is made of glass filled nylon, but any other material that has sufficient rigidity to produce an increasing spring force, in combination with the geometric shape, as the latch is flexed from its neutral position may be used. The material may also be a metallic based material such as a spring stainless steel or polymer coated spring steel. Again, in using a metallic material, the combination of the material spring properties and the geometric shape will produce a latch that has a neutral position that retains the handle in the proper location relative to the retention blocks of the roll up door and requires an increasing force to release the handle from this position. The roll up door handle latch 100 is preferably manufactured as a simplified single component rather than a complicated multiple piece assembly.

The spring portion 114 generates increasing spring force as the user pivots the roll up door handle latch 100. In the embodiment shown, the spring portion 114 is arcuate in shape that requires an increasing force as the radius increases or a flat shape that requires an increasing force as it forms an arc shape. The spring portion 114 is flexible so that the roll up door handle latch 100 may elastically deform, allowing the door handle 210 to pass around the blocks 260 thereby allowing the roll up door 200 to open. It is important that the geometric shape and design of the roll up door handle latch 100 allow for the required flexibility without causing the latch material to surpass its elastic deformation state and enter its plastic deformation state as this would reduce the tensioning forces applied to the door handle 210. Additionally, the roll up door handle latch 100 must be able to be opened and closed thousands of times without reducing the tensioning forces applied to the door handle. This may be accomplished by designing a roll up door handle latch 100 that would require a force so great to cause plastic deformation that it would be determined through analysis to be unreasonable for a force this great to be applied in use.

Between the spring portion 114 and the base 110 is a guard 118 that protects the top support 112 from falling objects. The top support 112 protrudes from the base 110, and the junction between the two elements is vulnerable to damage. The guard 118 provides material above the top support 112 to deflect any falling debris away from the junction. Additionally, in the embodiment shown, the guard 118 also acts as a secondary limiter, in the event the limiter 120 and limiter catch 122 fail to operate properly. If the top support 112 acts as a limiter, the end of the guard 118 contacts the roll up door 200 thereby preventing the top support 112 from being plastically, rather than elastically, deformed. FIG. 3A shows an alternative configuration of the guard 118. In the embodiment shown, the guard 118 protrudes from the base 110 rather than from between the spring portion 114 and the top support 112 as in the embodiment shown in FIG. 3. Of course, other types of guards may be used without departing from the invention.

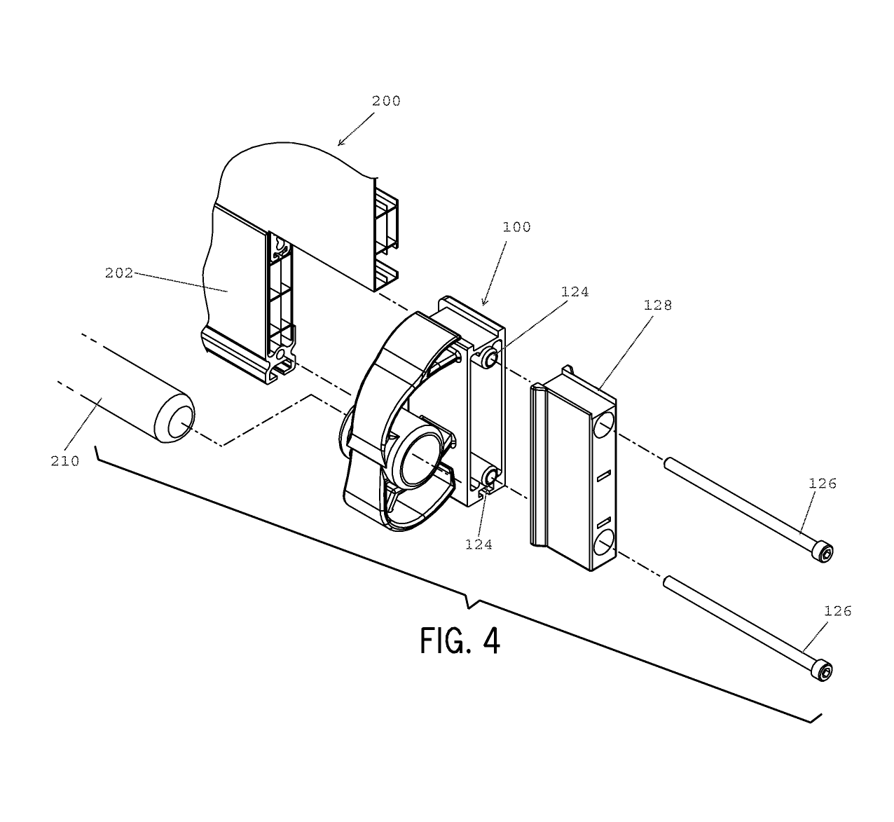

FIG. 4 shows how the roll up door handle latch 100 is attached to the roll up door 200. In the embodiment shown, the bottom slat 202 of the roll up door 200 is narrower than the rest of the slats. The narrowing of the bottom slat 202 allows the roll up door handle latches 100 to be attached to the bottom slat without increasing the overall width of the roll up door 200. The roll up door handle latch 100 includes a plurality of holes 124 thought which bolts 126 pass through, to secure the roll up door handle latch 100 to the bottom slat 202. In the embodiment shown, an end cap 128 is installed to the outside of the roll up door handle latch 100 to protect the roll up door handle latch 100 from excess wear that may be caused by the roll up door frame 250. Of course, the roll up door handle latch 100 may be attached to the roll up door 200 by alternate fastening means, such as conventional mounting blocks, without departing from the invention.

Turning now to FIGS. 5-7, the roll up door handle latch 100 is prevented from being plastically deformed by the limiter 120 and limiter catch 122. The limiter 120 is a protrusion extending from the base that includes a hook portion 121. The limiter catch 122 is formed at the end of the roll up door handle latch 100 away from the spring portion 114. In the embodiment shown, both the limiter 120 and the limiter catch 122 are incorporated into the roll up door handle latch 100 to prevent the spring portion 114 from opening too far. Alternatively, the limiter 120 and limiter catch 122 can be secondary components that are added to the roll up door handle latch 100, or a limiter 120 may be a component that is part of the roll up door 200 which the roll up door handle latch 100 to prevent overextension of the spring portion 114.

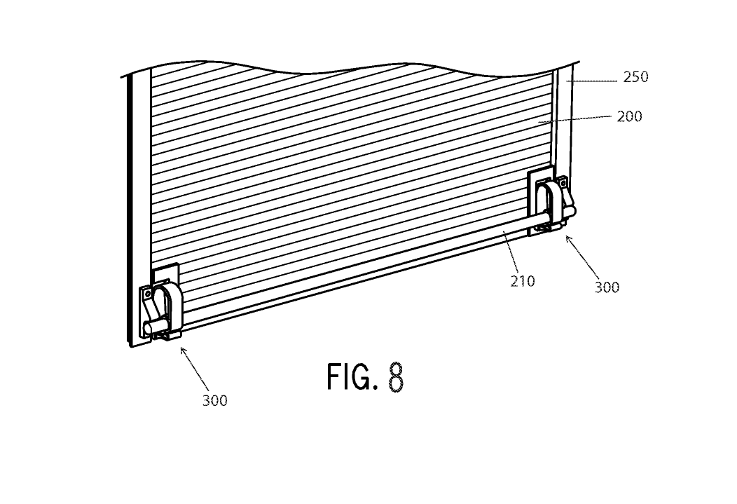

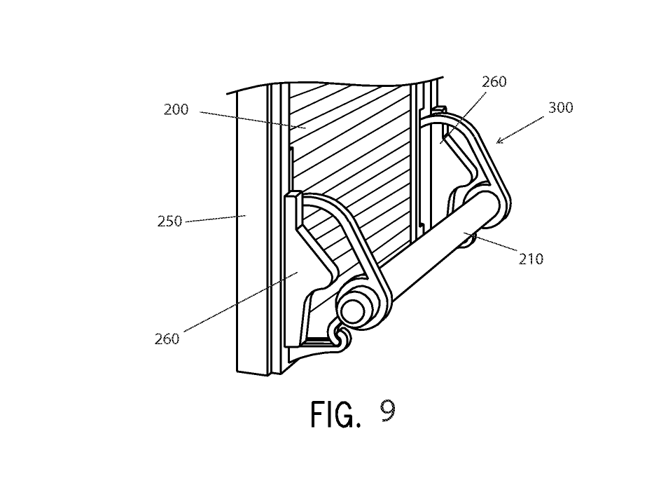

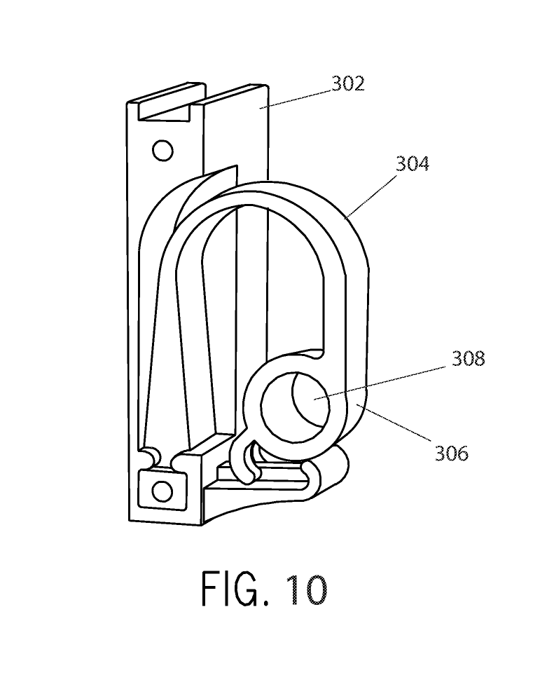

Turning now to FIGS. 8-16, an alternative embodiment of the invention is shown. In this alternative embodiment, a roll up door handle latch 300 includes a base 302 and a generally “U” shaped latch portion 304. As shown, the base 302 is made of corrosive resistant metal, and the latch portion 304 is made of any suitable resilient material. The latch portion 304 has a free end 306 that includes an opening 308 for inserting the door handle 210. The door handle 210 is removably attached to the opening 308.

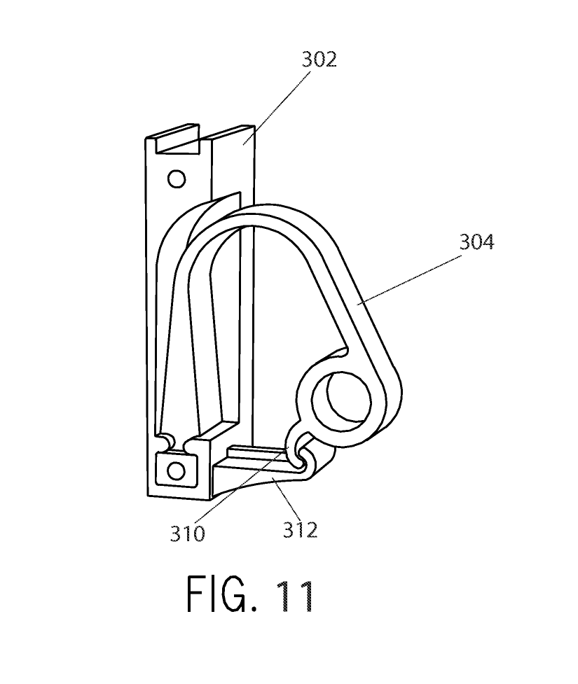

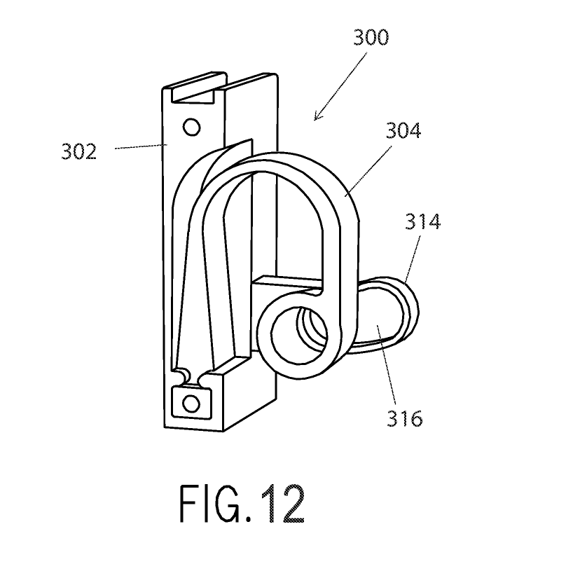

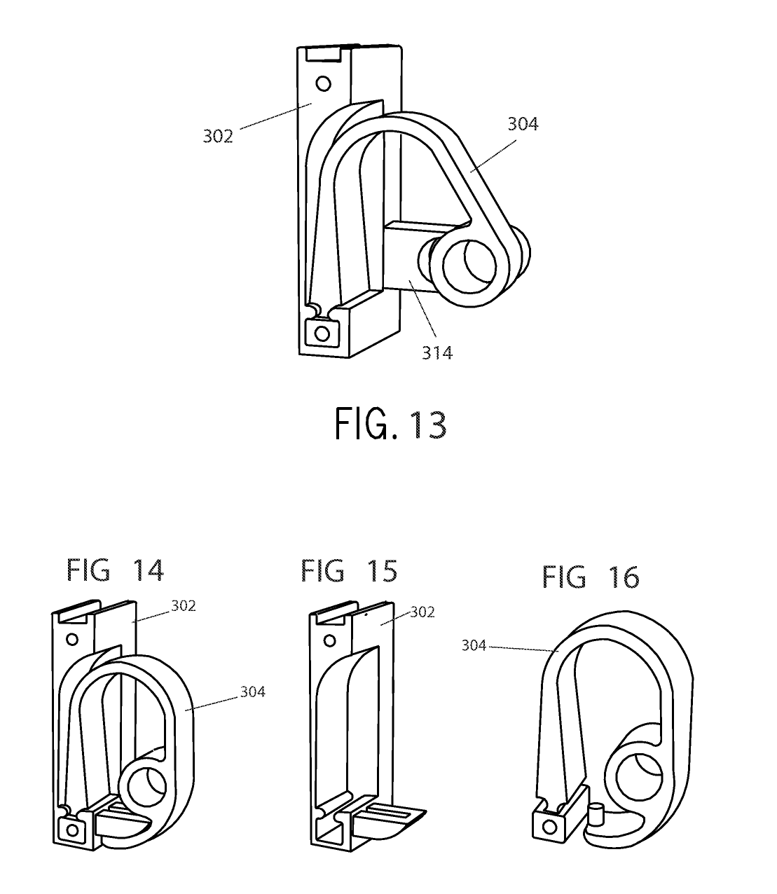

FIGS. 11-16 show three embodiments of a limiter and limiter catch used with the embodiment of the invention shown in FIGS. 8-16. Referring now to FIG. 11, a limiter catch 310 is shown that has a hook profile and protrudes from the free end of the latch portion 304. Below the limiter catch 310 is a limiter protrusion 312 that extends from the base 302. The limiter catch 310 prevents the latch portion 304 from over extending by engaging with the limiter protrusion 312 when the latch portion 304 pivots away from the roll up door 200. FIGS. 12-13 show an alternative embodiment of a limiter catch. A slotted protrusion 314 extends from the base 302. The slotted protrusion 314 includes a slot 316 that captures the door handle 210 to restrict the movement of the latch portion 304. FIG. 14-16 show a further embodiment of a limiter catch. A limiter protrusion 318 extends from the base 302 and includes a slot 318. A limiter catch 320 extends from the end of the latch portion 304 and is inserted into the slot 318 thereby restricting movement of the latch portion 304. Of course other limiter catch mechanisms may be used without departing from the invention.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A latch mechanism for use with a door comprising:
a base attached to a door;
a protrusion integrally formed and extending from the base including a support portion, a flexible spring arm portion, a door handle receiving opening, and a limiter catch;
the flexible spring arm portion including the door handle receiving opening positioned toward an end thereof, the spring arm portion for pivoting the door handle receiving opening away from the base and having a generally arcuate shape that progressively increases the force needed to extend the spring arm portion as it pivots away from the base;
a door handle disposed within the door handle receiving opening;
the limiter catch proximate to the door handle receiving opening; and
a limiter protrusion integrally formed and extending from the base that engages the limiter catch when the latch mechanism is actuated to prevent the flexible spring portion from extending beyond the elastic deformation limit of the flexible spring arm.

2. The latch mechanism of claim 1, further including a guard protruding from the flexible spring arm, the guard protecting the flexible spring arm from objects falling onto the latch mechanism.

3. The latch mechanism of claim 1, further including a guard protruding from the base, the guard protecting the flexible spring arm from objects falling onto the latch mechanism.

4. The latch mechanism of claim 1, wherein the base includes at least one fastener hole.

5. A latch mechanism for use with a door comprising:
a base attached to the door;
a flexible spring arm protruding from the base with a door handle receiving opening positioned at an end thereof;
a door handle disposed within the door handle receiving opening;
a limiter protruding from the base; and
a limiter catch proximate to the door handle receiving opening preventing the flexible spring arm from extending beyond the elastic deformation limit of the flexible spring arm by engaging the limiter when the latch mechanism pivots.

6. A latch mechanism for use with a door comprising:
a base integrally formed into a door;
a protrusion integrally formed and extending from the base including a support portion, a flexible spring arm portion, a door handle receiving opening, and a limiter catch;
the flexible spring arm portion including the door handle receiving opening positioned toward an end thereof, the spring arm portion for pivoting the door handle receiving opening away from the base and having a generally arcuate shape that progressively increases the force needed to extend the spring arm portion as it pivots away from the base;
a door handle disposed within the door handle receiving opening;
the limiter catch proximate to the door handle receiving opening; and
a limiter protrusion integrally formed and extending from the base that engages the limiter catch when the latch mechanism is actuated to prevent the flexible spring portion from extending beyond the elastic deformation limit of the flexible spring arm.
